(19) United States
(12) Patent Application Publication
(10) Pub. No.: US 2002/0186949 A1
(43) Pub. Date: Dec. 12, 2002

(54) Integrated rare earth doped optical waveguide amplifier array

(75) Inventor: Renyuan Gao, Strafford, PA (US)

Correspondence Address: Joseph E. Maenner, Monte & McGraw, P.C., 4007 Skippack Pike, P. O. Box 650, Skippack, PA, 19474, US

(73) Assignee: Photon-X, Inc., Malvern, PA

(21) Appl. No.: 09/971,157

(22) Filed: Oct. 4, 2001

Related U.S. Application Data
(63) Continuation-in-part of application No. 09/877,871, filed on Jun. 8, 2001.

(51) Int. Cl. G02B 6/122; G02B 6/26

(52) U.S. Cl. 385/132; 385/42; 385/142

(57) ABSTRACT

A channel waveguide optical amplifier is disclosed. The amplifier includes a substrate and an optical waveguide channel disposed on the substrate. The optical waveguide channel includes a first generally spiraling portion having a first free end and a first connected end, a second generally spiraling portion having a second free end and a second connected end, and a transition portion. The transition portion has a first transition section connected to the first connected end, a second transition section connected to the second connected end, and an inflection between the first and second transition sections. The amplifier also includes a directional coupler disposed on the substrate proximate the first free end. An amplifier assembly incorporating the channel waveguide is also disclosed.

### CROSS-REFERENCE TO RELATED APPLICATION

This application is a continuation-in-part of U.S. patent application Ser. No. 09/877,871, filed Jun. 8, 2001.

### FIELD OF THE INVENTION

The present invention relates to integrated optical amplification devices, specifically, optical waveguides and lasers.

### BACKGROUND OF THE INVENTION

Optical communication systems based on glass optical fibers (GOF) allow communication signals to be transmitted not only over long distances with low attenuation, but also at extremely high data rates, or bandwidth capacity. This capability arises from the propagation of a single optical signal mode in the low-loss windows of glass located at the near-infrared wavelengths of 850, 1310, and 1550 nm. Since the introduction of erbium-doped fiber amplifiers (EDFAs), the last decade has witnessed the emergence of single-mode GOF as the standard data transmission medium for wide area networks (WANs), especially in terrestrial and transoceanic communication backbones. In addition, the bandwidth performance of single-mode GOF has been vastly enhanced by the development of dense wavelength division multiplexing (DWDM), which can couple up to 80 channels of different wavelengths of light into a single fiber, with each channel carrying up to 10 gigabits of data per second. Moreover, recently, a signal transmission of greater than 1 terabit (1012 bits) per second has been achieved over a single fiber on a 60-channel DWDM system. Bandwidth capacities are increasing at rates of as much as an order of magnitude per year.

The success of the single-mode GOF in long-haul communication backbones has given rise to the new technology of optical networking. The universal objective is to integrate voice video, and data streams over all-optical systems as communication signals make their way from WANs down to smaller local area networks (LANs) of Metro and Access networks, down to the curb (FTTC), home (FTTH), and finally arriving to the end user by fiber to the desktop (FTTD). Examples are the recent explosion of the Internet and use of the World Wide Web, which are demanding vastly higher bandwidth performance in short- and medium-distance applications. Yet, as the optical network nears the end user starting at the LAN stage, the network is characterized by numerous splittings of the input signal into many channels. This feature represents a fundamental problem for optical networks. Each time the input signal is split, the signal strength per channel is naturally reduced.

Rare earth doped optical amplifiers are emerging as the predominant optical signal amplification device for every aspect of optical communication networks spanning from repeaters, pre-amplifiers, and power boosters to in-line amplifiers for wavelength division multiplexed (WDM) systems. These amplifiers are suitable for long-haul, submarine, metro, community antenna television (CATV) and local area networks. An optical amplifier amplifies an optical signal directly in the optical domain without converting the signal into an electrical signal and reconverting the electrical signal back to an optical signal. As optical telecommunication networks push further and further toward the end user, as represented by the technology of FTTC, FTTH, and FTTD, there is an ever growing demand for compact and low cost optical amplification devices.

The key to an optical signal amplifier device is the gain medium. Gain media are typically made by doping rare earth ions into the core of an optical fiber. However, rare earth doped optical fiber has the disadvantage of high-cost, long length and difficulty of integration with other optical components, such as optical couplers, splitters, detectors, and diode lasers, resulting in high cost of manufacturing and bulkiness of the devices. As a cost-effective alternative to doped fibers, doped waveguides can be used as an amplification medium. Waveguides provide a benefit over fibers of being able to amplify a light signal over a significantly smaller area than fiber.

FIG. 1 shows a typical structure of a prior art integrated waveguide optical amplifier 20. The optical gain medium is formed by various processes (e.g. modified chemical vapor deposition, ion exchange, photolithography, flame-hydrolysis, reactive ion-etching, etc.) and the resulting gain medium is a straight line rare earth (RE) doped waveguide 22. The RE doped waveguide 22 is pumped by a pump laser 24, which generates a pump light λₚ. Preferably, the pump laser 24 operates at approximately 980 nm, 1060 nm, or 1480 nm, although those skilled in the art will recognize that the pump laser 24 can operate at other wavelengths as well. The pump light πₚ is combined with the optical signal λₛ to be amplified (e.g. 1530 nm-1610 nm for an erbium doped channel waveguide) by a multiplexer 26. Optical isolators 28 are inserted into the optical path to prevent back-reflected signal amplification in the RE doped channel waveguide 22. The waveguide amplifier 20 may be used either as a signal amplifier as illustrated in FIG. 1 or as a laser 30 as illustrated in FIG. 2. In the latter case, reflection devices such as mirrors or fiber and waveguide gratings 32 are included in the optical path to create a laser oscillation cavity.

In order to achieve a desired 10 dB-30 dB signal gain in the amplifier 20, or to achieve laser output in the waveguide laser 30, a relatively high concentration of the rare earth ions are required, since the waveguide substrate (e.g. a four inch silicon wafer) can only accommodate a straight line waveguide with a length that is no longer than the waveguide substrate diameter. High concentration of rare earth ions can lead to problems such as ion clustering and lifetime quenching, which in turn reduce the amplifier performance. Furthermore, the straight line amplification waveguide can be required to be more than 10 cm long, which requires the dimension of the amplifier device to be greater than 10 cm in length, thus making it impractical to build the amplifier device more compact. Prior art as exemplified in U.S. Pat. No. 5,039,191 (Blonder et al.),U.S. Pat. No. 6,043,929 (Delavaux et al.), U.S. Pat. No. 5,119,460 (Bruce et al.), PCT Publication WO 00/05788 (Lawrence et al.), and J. Schmulovish, A. Wong, Y. H. Wong, P. C. Becker, A. J. Bruce, R. Adar “Er³⁺ Glass Waveguide Amplifier at 1.55 μm on Silicon,” Electron. Lett., Vol. 28, pp.1181-1182, 1992 all disclose such straight line waveguides.

It would be beneficial to have a curved channel waveguide that is contained on a relatively small area on a substrate, hence increasing the amplification channel waveguide length and reducing the overall size of the amplifier. Bruce et al. as well as M. Ohashi and K. Shiraki, “Bending Loss Effect on Signal Gain in an Er³⁺ Doped Fiber Amplifier,” IEEE Photon. Technol. Lett., Vol. 4., pp.192-194, 1992 disclose a curved zig-zag shaped channel waveguide 40 to increase the channel length, as shown in FIG. 3. However, this approach creates the problem of high bending losses at turning regions 42 in the curved waveguide 40. The bending radius is R_{bending}=(½ n) R_{substrate} where n is the number of channel waveguide curve turning regions 42. Due to the high bending curvature, or small bending radius, the bending loss of such waveguide 40 is extremely high, resulting in low signal gain and limited usable waveguide channel length. Another approach is to use a spiral type waveguide with a plurality of 90° bends to reduce the amount of area required for the waveguide, as is shown in FIG. 4. However, because of the tight bend radius at each of the 90° bends, a substantial amount of light is lost at each bend.

Due to the disadvantages of the prior art described above, an optimized bending shape is desired to achieve more compact and integrated amplifier devices at lower manufacturing cost and without the losses exhibited by current curved waveguides.

### BRIEF SUMMARY OF THE INVENTION

Briefly, the present invention provides a channel optical waveguide. The channel optical waveguide comprises a substrate; and a first optical waveguide channel disposed on the substrate. The first optical waveguide channel includes a first generally circular spiraling portion having a first free end and a first connected end, a second generally circular spiraling portion having a second free end and a second connected end, and a transition portion. The transition portion has a first transition section connected to the first connected end, a second transition section connected to the second connected end and an inflection between the first and second transition sections. The channel optical waveguide also comprises a directional coupler disposed on the substrate proximate the first free end.

The present invention also provides a channel waveguide optical amplifier assembly. The assembly comprises a waveguide optical amplifier including a substrate; and a first optical waveguide channel disposed on the substrate. The first optical waveguide channel includes a first generally circular spiraling portion having a first free end and a first connected end, a second generally circular spiraling portion having a second free end and a second connected end, and a transition portion. The transition portion has a first transition section connected to the first connected end, a second transition section connected to the second connected end and an inflection between the first and second transition sections. The channel optical waveguide also comprises a directional coupler disposed on the substrate proximate the first free end. The assembly further comprises a first pigtail assembly having a first input portion optically connected to the first free end and a second input portion optically connected to the directional coupler.

### BRIEF DESCRIPTION OF THE DRAWINGS

The accompanying drawings, which are incorporated herein and constitute part of this specification, illustrate the presently preferred embodiments of the invention, and, together with the general description given above and the detailed description given below, serve to explain the features of the invention. In the drawings:

FIG. 1 is a schematic of a prior art amplifier device.

FIG. 2 is a schematic of a prior art laser.

FIG. 3 is a top plan view of a first prior art waveguide.

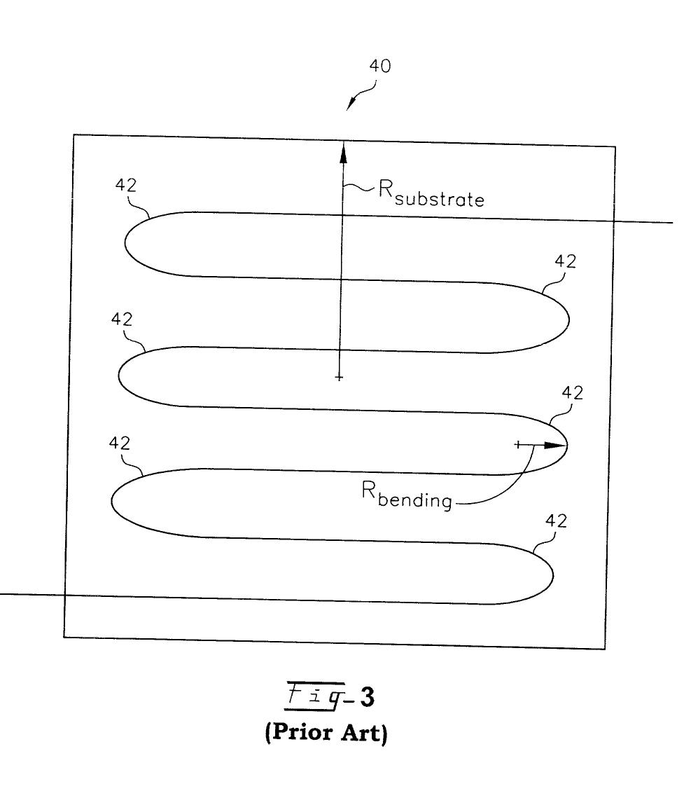

FIG. 4 is a top plan view of a second prior art waveguide.

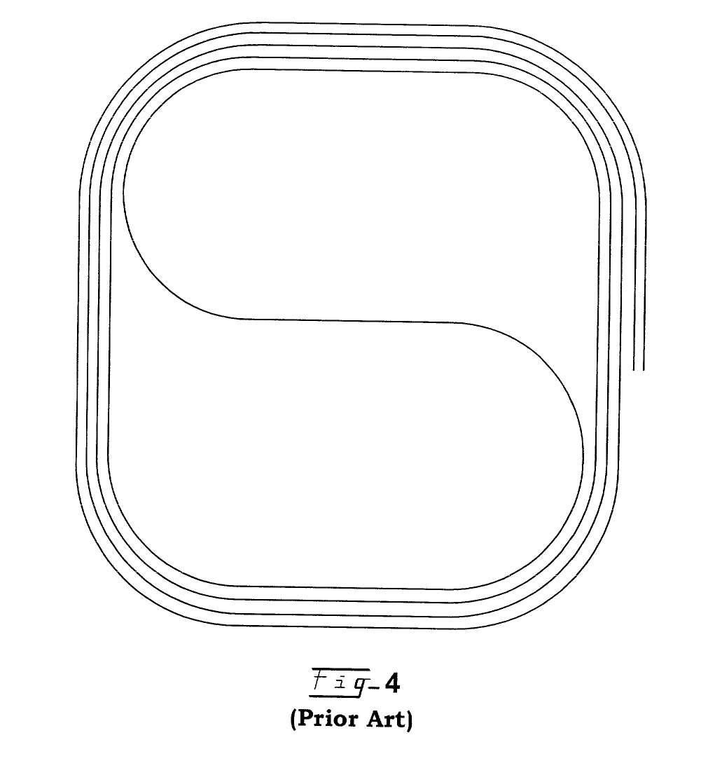

FIG. 5 is a top plan view of a waveguide according to a first embodiment of the present invention.

FIG. 6 is a partial side view, in section, of the waveguide of FIG. 5 taken along lines 6-6 of FIG. 5.

FIG. 7 is a top plan view of a pumping mechanism of a double cladded waveguide amplifier.

FIG. 8 is a partial side view, in section, of the waveguide of FIG. 7 taken along lines 8-8 of FIG. 7.

FIG. 9 is a top plan view of an additional embodiment of the present invention.

FIG. 10 is a top plan view of another embodiment of the present invention.

FIG. 11 is a top plan view of an additional embodiment of the present invention.

FIG. 12 is a cross-sectional view of an alternate embodiment of the present invention.

### DETAILED DESCRIPTION OF THE INVENTION

In the drawings, like numerals indicate like elements throughout. Reference is made to U.S. patent application Ser. Nos. 09/507,582, filed Feb. 18, 2000; 09/722,821, filed Nov. 28, 2000; 09/722,822, filed Nov. 28, 2000; 60/253,225, filed Nov. 27, 2000; and 60/314,902, filed Aug. 24, 2001, which are all owned by the assignee of the present invention and are all incorporated by reference herein in their entireties.

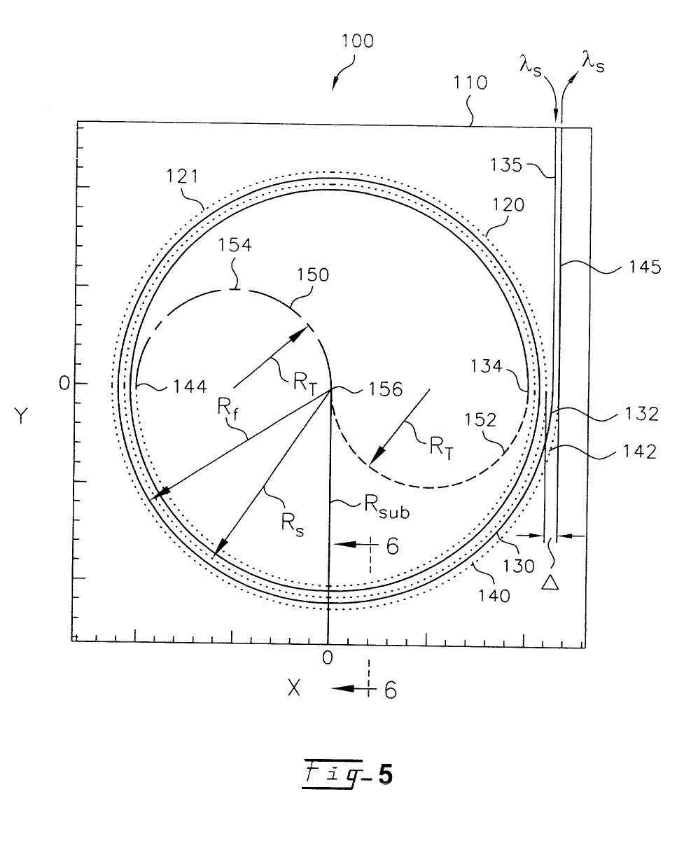

FIG. 5 is a top plan view of the basic structure of a first embodiment of a channel waveguide amplifier 100 in accordance with the present invention. The waveguide amplifier 100 uses a generally circular double spiral structure that maximizes the usage of the area of a substrate 110 and maximizes the bending radius of a waveguide 120 disposed on the substrate 110. On a substrate of a defined size, the usable length of the optimized curved amplifier waveguide 120 is not limited by the substrate length or diameter. The bending radius on the waveguide amplifier 100 is about half of the radius R_{sub} of the substrate 110 in the center part of the waveguide 120 and is approximately equal to the radius R_{sub} of the substrate 110 in the outer part of the waveguide 120. The width of each channel 121 (preferably approximately 5 micrometers) of the waveguide 120 is much smaller than the diameter or the width of the substrate 110 (e.g. about 10-15 centimeters), and the separation between channels 121 of the waveguide 120 is also much smaller than the diameter or the width of the substrate 110. As a result, the separation between adjacent channels 121 of the waveguide 120 can be as small as approximately 100 micrometers. Although only five winding channels 121 are shown in FIG. 5, the number of winding channels 121 can be on the order of hundreds, greatly increasing the amplification channel length, and at the same time maintaining the relatively large bending radius necessary for desired small bending losses.

The substrate 110 is preferably constructed from optical materials, such as silicon, various glasses (e.g. silicate and phosphate glasses), polymers, crystals (e.g. titanium diffused lithium niobate, or Ti:LiNbO₃) as well as other optical materials, as will be recognized by those skilled in the art. There are various known ways of forming channel waveguides, including RE doped waveguides, on optical substrate materials. These methods include, but are not limited to: vapor deposition, ion exchange, photolithography, flame hydrolysis, reactive ion etching, etc. These techniques are well known to those skilled in the art, and will not be further discussed herein. It is to be understood that the herein disclosed structural layout can be implemented on any waveguide materials with any waveguide fabrication methods.

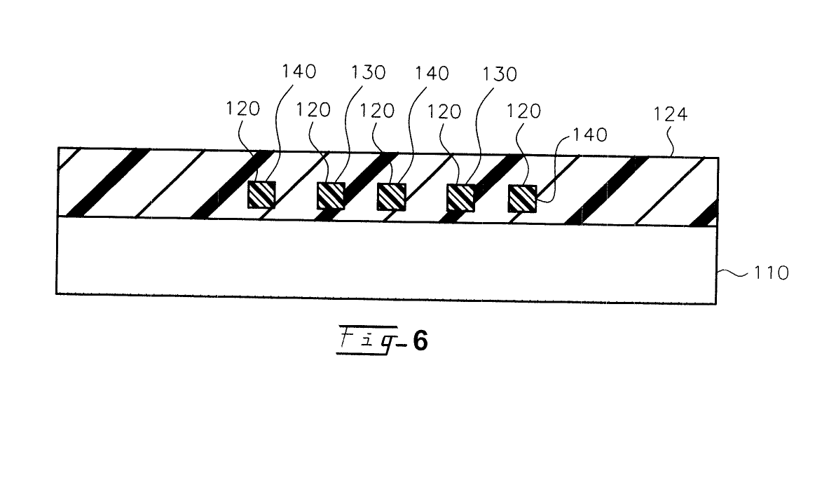

FIG. 6 is a cross-sectional view of the first embodiment, which shows that the waveguide amplifier 100 contains the RE doped waveguide 120 embedded within a cladding region 124, with the cladding region 124 being disposed directly on the optical substrate 110. Preferably, the cross-sectional dimensions of the cladding region 124 are between approximately 1 and 2 millimeters wide and between approximately 5 and 50 micrometers high, although those skilled in the art will recognize that the cladding region 124 can have other cross-sectional dimensions as well. Although the cross-sectional size of the waveguide channel 122 is preferably approximately 5 micrometers, the cross-sectional size of the waveguide channel 122 can be between approximately 1 to 15 micrometers, depending in the refractive index difference between the material comprising the waveguide 120 and the cladding 124. For a relatively small refractive index difference (approximately 0.2%), the cross-sectional size is preferably closer to 15 micrometers, and for a relatively large refractive index difference (approximately 5%), the cross-sectional size is preferably closer to 1 micrometer.

As illustrated in FIG. 6, the cross-sectional shape of the channel 122 is preferably square, for ease of fabrication and splicing with optical fibers, as well as reduced polarization effects, but the channel 122 can be other shapes, such as rectangular or circular. The winding of the channels 122 follows a generally circular spiral curve as shown in FIG. 5 to minimize light losses and optimize signal transmission through the waveguide 120.

It can be shown that, for a prior art generally square waveguide, such as the waveguide shown in FIG. 5, with 90° bends having an approximate radius of 10 millimeters, the waveguide bends the 90° over a distance of 5π millimeters, while a generally circular waveguide 120 having an approximate radius of 25 millimeters bends only 36° over a distance of 5π millimeters. The reduced bending in the waveguide 120 retains more light within the waveguide 120 than the prior art waveguide, the amount of which depends on several factors, including the numerical aperture of the waveguide and the number of turns on the waveguide 120.

Preferably, the waveguide 120 is constructed from either an optical glass or an optical polymer, such as the phosphate glass disclosed in co-pending U.S. patent application Ser. No. 60/253,225, filed Nov. 27, 2000, or a polymer disclosed in any of co-pending U.S. patent application Ser. Nos. 09/507,582, filed Feb. 18, 2000; 09/722,821, filed Nov. 28, 2000; 09/722,822, filed Nov. 28, 2000; or 60/314,902, filed Aug. 24, 2001, which are all owned by the assignee of the present invention and are all incorporated herein by reference in their entireties. The rare earth element in the waveguide 120 preferably consists of one of the group of lanthanum, cerium, praseodymium, neodymium, promethium, samarium, europium, gadolinium, terbium, dysprosium, holmium, erbium, thulium, ytterbium, and lutetium. However, those skilled in the art will recognize that other elements, as well as combinations of elements, can be used. For example, a co-dopant rare earth polymer with two of the above-mentioned rare earths or one of the above-mentioned rare earths and a metal, such as aluminum, can be used.

Referring to FIG. 5, the waveguide 120 comprises a first generally circular spiraling portion 130, a second generally circular spiraling portion 140, and a transition portion 150. The first generally circular spiraling portion 130, represented by the solid line, has a first free end 132 and a first connected end 134. A generally straight connector portion 135 connects with the first free end 132 and extends to the end of the substrate 110. The generally straight connector portion 135 provides an optical connection from an input fiber (not shown) to the waveguide 100. Although the first spiraling portion 130 has a constantly decreasing first radius R_{f} from the first free end 132 to the second free end 134, the first radius R_{f} decreases so insignificantly that the first radius R_{f} can be treated as being approximately a constant first radius R_{f}. The second generally circular spiraling portion 140, represented by the dotted line, has a second free end 142 and a second connected end 144. A generally straight connector portion 145 connects with the first free end 142 and extends to the end of the substrate 110. The generally straight connector portion 145 provides an optical connection to an output fiber (not shown) to the waveguide 100. Although the second spiraling portion 140 has a constantly decreasing second radius Rₛ from the second free end 142 to the second connected end 144, the second radius Rₛ decreases so insignificantly that the second radius Rₛ can also be treated as being approximately a constant second radius Rₛ, which is approximately equal to the approximate first radius R_{f}. Additionally, the first and second radii R_{f}, Rₛ, respectively, can be approximately equal to, but slightly less than, the substrate radius R_{Sub}. The first and second generally circular spiraling portions 130, 140 are generally intertwined with each other such that, as shown in FIG. 6, the first and second generally circular spiraling portions 130, 140 alternate with each other as viewed from left to right.

The transition portion 150 has a first transition section 152, represented by the dashed line, which is curved in a first direction and is connected to the first connected end 134. The transition portion 150 also includes a second transition section 154, represented by the broken line, which is curved in a second direction and is connected to the second connected end 144. An inflection 156 is located between and connects the first transition section 152 and the second transition section 154. The inflection 156 reverses the curvature of the transition portion 150. As shown in FIG. 5, the inflection 156 is located generally in the geometric center of the waveguide amplifier 100. Such location of the inflection 156 maximizes use of space on the substrate 110 and maximizes the radii R_{f}, Rₓ. The first transition section 152 and the second transition section 154 each have an approximate transition radius Rₜ approximately one half of the approximate first radius R_{f}.

Preferably, the shape of the waveguide 120, from the input 132 to the output 142, can be represented by the following set of equations:

First generally circularly spiraling portion 130:

X=(R+Δ·θ/2π)·cos θ; Y=(R+Δ·θ/2π)·sin θ,

θ=[2nπ,0] Equation 1

First transition section 152:

X=(R/2)+(R/2)·cos θ; Y=(R/2)·sin θ, θ=[0, −π] Equation 2

Second transition section 154:

X=(R/2)−(R/2)·cos θ; Y=(R/2)·sin θ, θ=[0, π] Equation 3

Second generally circularly spiraling portion 140:

X=(R+Δ·θ/2π+Δ/2)·cos θ;

Y=(R+Δ·θ/2π+Δ/2)·sin θ, θ=[−π, 2nπ] Equation 4

where n is the number of turns on each of the first and second generally circularly spiraling portions 130, 140; R is the smallest radius of the first generally circularly spiraling portion 130; X is the X coordinate of each point on each portion 134, 140 and each section 152, 154; Y is the Y coordinate of each point on each portion 134, 140 and each section 152, 154; Δ is the separation of adjacent lines on each of the first and second generally circularly spiraling portions 130, 140; and θ is the angle swept through by each portion 134, 140 and each section 152, 154. Although the preferred shape of the waveguide 120 is described by Equations 1-4, those skilled in the art will recognize that other similar, but different, shapes can be described by other equations.

An input light signal λₛ can be injected at the first free end 132 for transmission through the waveguide 120. Preferably, the input light signal λₛ is a broadband signal encompassing approximately 100 nanometers. A pump laser can be combined with a signal laser into a single mode optical fiber through a wavelength division multiplexer (not shown) and aligned with the first free end 132 so that pump light from the pump laser can be directed into the waveguide 120 with the input light signal λₛ. The input light signal λₛ, can then be amplified during transmission through the waveguide 120, and outputted from the second free end 142.

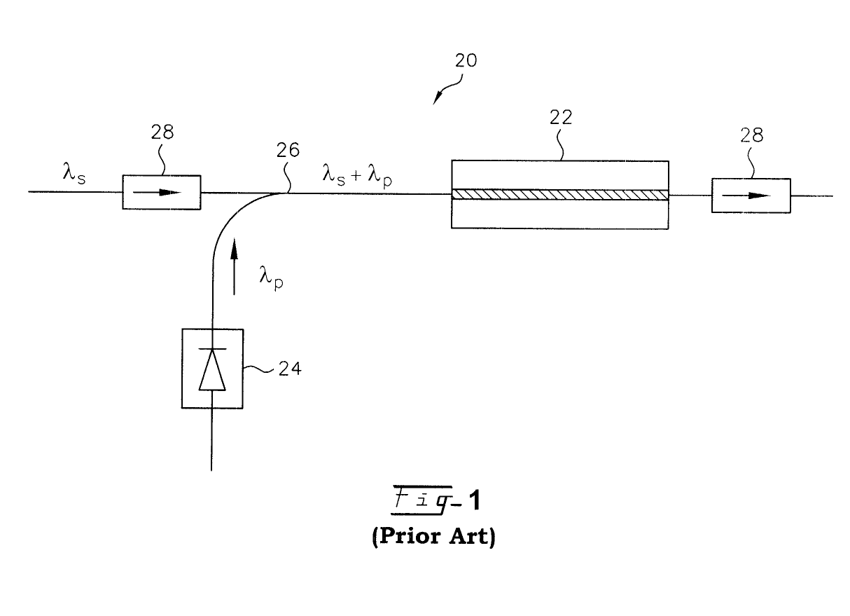

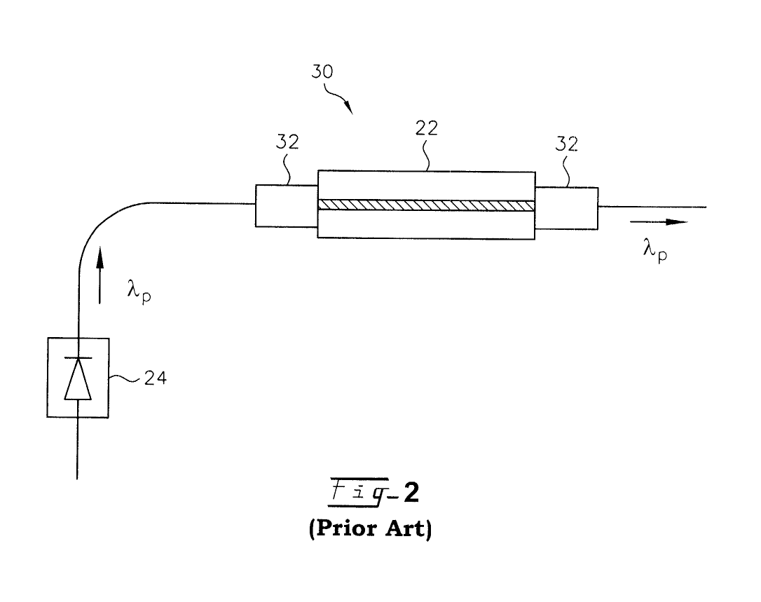

The waveguide amplifier 100 can be used in an optical amplifier or a laser, such as the prior art amplifier 20 shown in FIG. 1 or the prior art laser 20 shown in FIG. 2, with the prior art waveguide 22 removed and the waveguide amplifier 100 installed therefor.

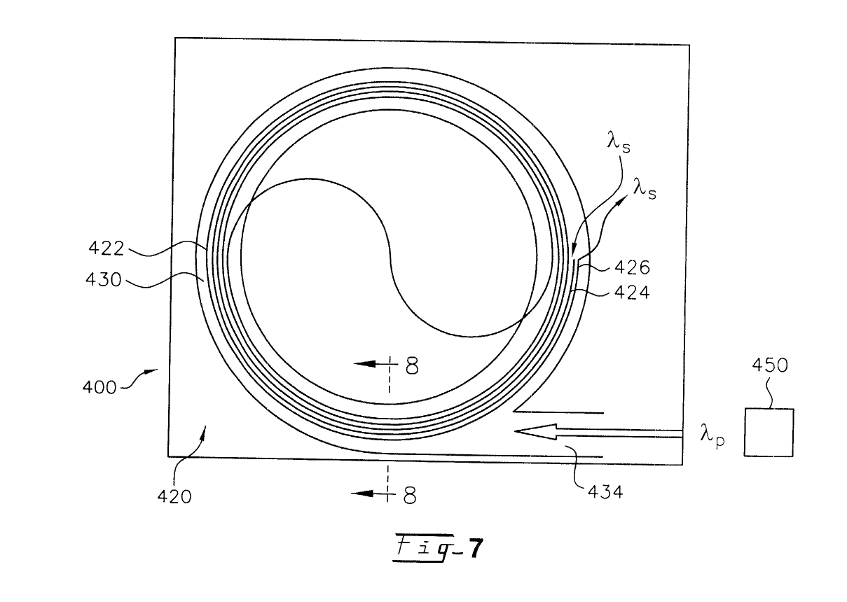

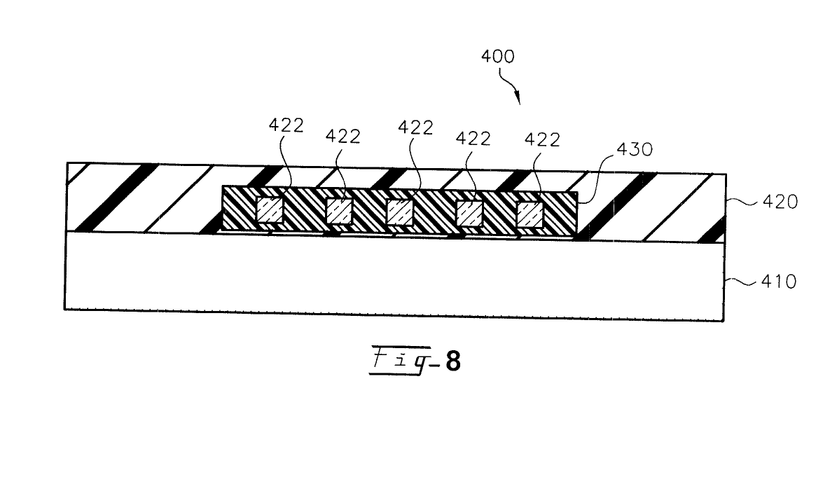

FIGS. 7 and 8 disclose a novel pumping mechanism of an RE doped channel waveguide amplifier 400 according to the principles of the present invention. The waveguide amplifier 400 is similar to the waveguide amplifier 100. However, as seen in FIG. 8, the waveguide amplifier 400 includes a first cladding layer 420 disposed on a substrate 410 and a second cladding layer 430 embedded in the first cladding layer 420. As shown in FIG. 7, a generally spiral-shaped rare earth doped optical waveguide 422, similar in shape to the waveguide 120, is embedded in the second cladding layer 430. The waveguide 422 has a first free end 424 at which a signal light λₛ is inputted and a second free end 426 at which the signal light λₛ, having been amplified by pump light λₚ, is outputted.

The first waveguide cladding layer 420 has a refractive index lower than that of the second cladding layer 430, with the refractive index of the second cladding layer 430 being lower than the refractive index of the waveguide 422. As can be seen from FIG. 7, the second cladding layer 430 is generally annularly shaped and includes a lead-in portion 434 which extends generally tangentially from the annularly shaped portion of the second cladding layer 430. Although the second cladding layer 430 is preferably generally annularly shaped, those skilled in the art will recognize that the second cladding layer 430 need not necessarily be generally annularly shaped.

The first cladding layer 420 preferably has a width of about 20 micrometers to 500 micrometers, and a height of about 5 micrometers to 50 micrometers, in order to be large enough to surround the waveguide channel 422. The waveguide 422 is designed to support single mode propagation of both the signal light λₛ at approximately 1300 nm or 1550 nm, depending on the rare earth dopant, and the pump light λₚ at wavelengths such as 800 nm, 980 nm, 1060 nm, 1480 nm, or other known pump light wavelengths, while the second cladding layer 430 is designed to support multiple modes of the pump light λₚ from a multimode pump laser.

The pump laser 450 is disposed proximate the waveguide amplifier 400 such that pump light λₚ from the pump laser 450 is directed generally tangentially into the second cladding layer 430 along the lead-in portion 434.

In operation, signal light λₛ is injected into the waveguide 120 at the first free end 132 of the first generally circular spiraling portion 130. The signal light travels along the waveguide 120 through the first generally circular spiraling portion 130, the inflection 150, and the second generally circular spiraling portion 140, and out the waveguide 120.

Multimode pump light λₚ is injected into the second cladding layer 430 as is illustrated in FIG. 7. As the pump light λₚ propagates within the second cladding layer 430, the pump modes overlap spatially with the waveguide 422 and the pump light λₚ is absorbed by the rare earth ions in the waveguide 422. The pump light absorption in turn causes rare earth ion excitation and signal amplification, as is well known by those skilled in the art. The difference in the refractive indices between the first cladding layer 420 and the second cladding layer 430 keeps generally all of the pump light from exiting the second cladding layer 430, as will be understood by those skilled in the art.

The overall size of the waveguide amplifier 400 depends on the refractive index difference (Δn) between the channel waveguide 422 and the second cladding layer 430 surrounding the channel waveguide 422. The larger the Δn, the smaller the bending radius or diameter, and therefore the smaller the waveguide amplifier 400 can be. The size limit of the waveguide amplifier 400 is set by three factors: (1) waveguide bending loss dependence on bending curvature for given waveguide and cladding materials; (2) coupling losses on the input and output to singlemode fibers; and, to a lesser degree, (3) the change in the pump light λₚ and the signal light λₛ mode overlap with the RE doped waveguide 422 due to bending induced mode peak shift from the center of the waveguide 422.

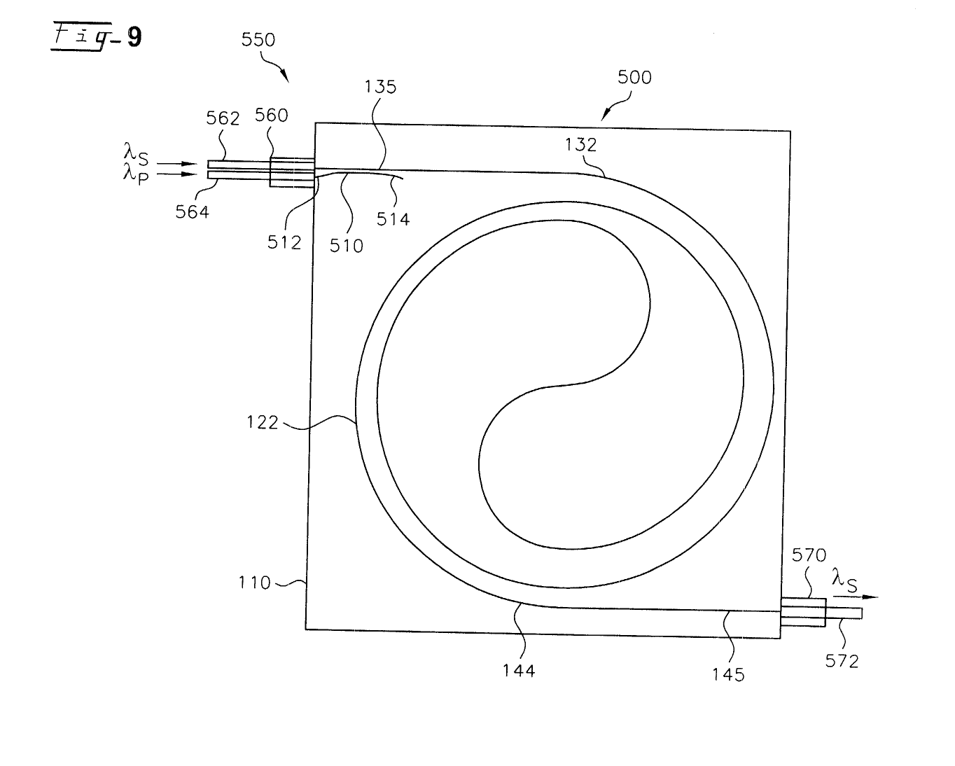

An alternate embodiment of the present invention is shown in the waveguide amplifier 500 shown in FIG. 9. The waveguide amplifier 500 includes the curved waveguide 122 disposed on the substrate 110 as described above with respect to the first embodiment waveguide amplifier 100. In addition, the amplifier 500 also includes a directional coupler 510 disposed on the substrate 110 proximate the first free end 132. Preferably, the directional coupler 510 is disposed approximately 1 to 5 microns from the waveguide 122. The directional coupler 510 has a connection end 512 and a terminating end 514. The directional coupler 510 is preferably constructed from a polymer, including but not limited to, any of the polymers described in U.S. patent application Ser. Nos. 09/507,582, filed Feb. 18, 2000; 09/722,821, filed Nov. 28, 2000; 09/722,822, filed Nov. 28, 2000; and 60/314,902, filed Aug. 24, 2001, poly[2,2-bistrifluoromethyl-4,5-difluoro-1,3-dioxole-co-tetrafluoroethylene] (sold under the trademark TEFLON® AF), poly[2,3-(perfluoroalkenyl) perfluorotetrahydrofuran] (sold under the trademark CYTOP®), poly[2,2,4-trifluoro-5-trifluoromethoxy-1,3-dioxole-co-tetrafluoroethylene] (sold under the trademark HYFLON® AD), although those skilled in the art will recognize that other light transmitting media, including but not limited to optical glasses, can be used. The directional coupler 510 is disposed to transmit light between the directional coupler 510 and the first free end 132, as is well known in the art.

The waveguide amplifier 500 is part of a waveguide amplifier assembly 550 that also includes a first pigtail assembly 560 and a second pigtail assembly 570. The first pigtail assembly 560 has a first input portion, such as a fiber 562, optically connected to the first free end 132 through the generally straight connector portion 135 on the waveguide channel 122 and a second input portion, such as a fiber 564, optically connected to the connection end 512 of the directional coupler 510. The second input portion 564 also can be optically connected to a pump laser (not shown) so that the directional coupler 510 is optically connected to the pump laser. The second pigtail assembly 570 is optically connected to the second free end 142 through the generally straight connector portion 145. An output of the second pigtail assembly 570 is optically connected to an output, such as a fiber 572.

In operation, a signal light λ_{S} is transmitted along the fiber 562 to the first pigtail assembly 560 and to the connector portion 135. A pump light λ_{P} is transmitted along the fiber 564 to the first pigtail assembly 560 and the directional coupler 510. Since the connector portion 135 and the directional coupler 510 are sufficiently close to each other, some of the pump light λ_{P} transfers to the connector portion 135 and combines with the signal light λ_{S}. Preferably, the pump light is a 980 nm or a 1310 nm pump, whose light excites rare earth elements in the connector portion 135 and the waveguide channel 122, amplifying the signal light λ_{S} in the connector portion 135 and the waveguide channel 122. An amplified light signal λ_{S} exits the second pigtail assembly 570 through the fiber 572 for further transmission.

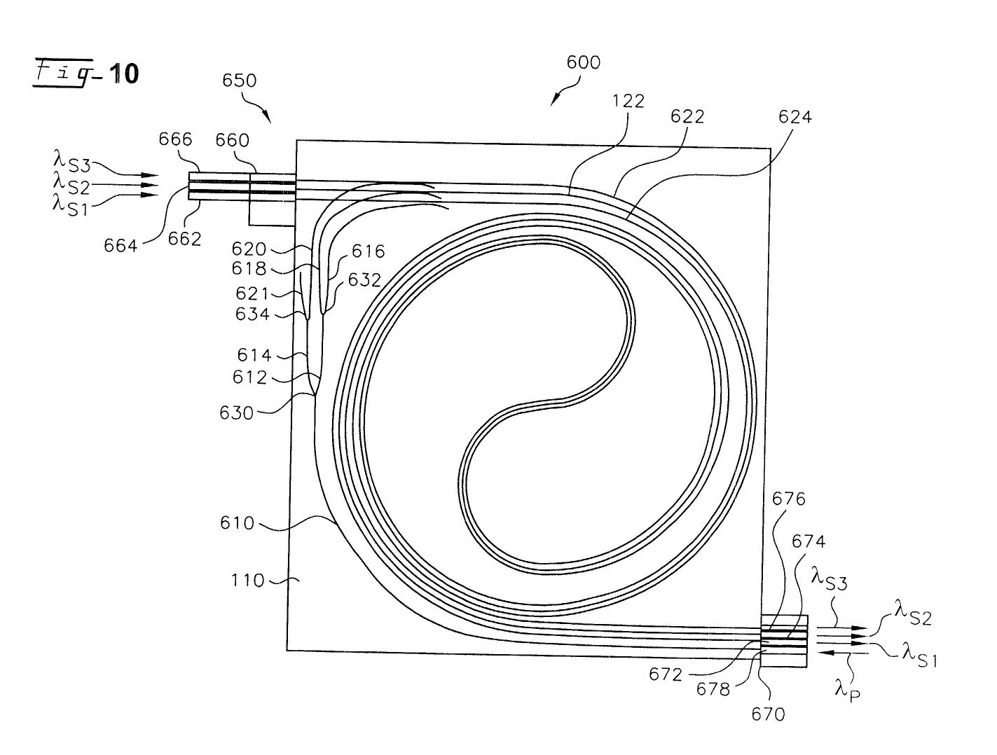

Another alternate embodiment of the present invention is shown in the waveguide amplifier 600 shown in FIG. 10. In addition to the waveguide channel 122, at least a second optical waveguide channel 622 is also disposed on the substrate 110 and preferably follows a path generally parallel to the path defined by the waveguide channel 122. Although in FIG. 10, two additional waveguide channels 622, 624 are shown, those skilled in the art will recognize that more or less than two additional waveguide channels 622, 624 can be used. Preferably, the total number of waveguide channels is a power of the numeral 2 (1, 2, 4, 8, 16, etc.) for reasons that will become apparent. Also preferably, spacing between adjacent waveguide channels 122, 622 and 122, 624 is between 20 to 200 microns, although those skilled in the art will recognize that other spacings can be used.

A directional coupler 610 is split into multiple coupler sections 612, 614, by pump beam splitter 630. Coupler section 612 is subsequently split into coupler sections 616, 618 by pump beam splitter 632 and coupler section 614 is subsequently split into coupler sections 620, 621 by pump beam splitter 634. As shown in FIG. 10, coupler section 616 couples pump light to waveguide channel 624, coupler section 618 couples pump light to waveguide channel 122, and coupler section 620 couples pump light to waveguide channel 624. As shown in FIG. 10, coupler section 621 has no waveguide channel with which to couple, so coupler section 621 merely ends. Alternatively, the coupler section 621 can be used as a tap.

Preferably, the total number of coupler sections 616, 618, 620, 621 is a power of the numeral 2 (1, 2, 4, 8, 16, etc.) so that a pump light λₚ is divided evenly among each of the coupler sections 616, 618, 620, 621. Pump beam splitter 630 splits the pump light λₚ in half and pump beam splitters 632, 634 further split the pump light λₚ in quarters. So that coupler section 614 does not provide twice the pump power to waveguide channel 622 as coupler sections 616, 618 provide to waveguide channels 122, 624, coupler section 614 is split by pump beam splitter 634 into coupler sections 620, 621, with coupler section 620 providing the same pump power to waveguide channel 622 as coupler sections 616, 618 provide to waveguide channels 624, 122, respectively, with coupler section 621 ending without coupling with any waveguide channel.

As seen in FIG. 10, coupler section 618 crosses over waveguide channel 624 and coupler section 620 crosses over both waveguide channel 624 and 122. Preferably, each cross over is at approximately a 45 degree angle and introduces a minimum loss, approximately on the order of 0.15-0.20 dB.

The waveguide amplifier 600 is part of a waveguide amplifier assembly 650 that also includes a first pigtail assembly 660 and a second pigtail assembly 670. The first pigtail assembly 660 has a plurality of input portions, such as fibers 662, 664, 666, each optically connected to a waveguide channel 122, 622, 624. The second pigtail assembly 670 has a plurality of output portions, such as fibers 672, 674, 676, each optically connected to a waveguide channel 122, 622, 624. The second pigtail assembly 670 also has a pump input 678 optically connected to the directional coupler 610, and to a pump laser (not shown) so that the directional coupler 610 is optically connected to the pump laser. Although the pump input 678 is shown as being part of the second pigtail assembly 670, those skilled in the art will recognize that the pump input 678 can be part of the first pigtail assembly 660, instead.

Operation of the waveguide assembly 650 is as follows. A signal light λ_{S1} is transmitted along the fiber 662 to the first pigtail assembly 660 and through the first pigtail assembly 660 to the waveguide channel 624. A signal light λ_{S2} is transmitted along the fiber 664 to the first pigtail assembly 660 and through the first pigtail assembly 660 to the waveguide channel 122. A signal light λ_{S3} is transmitted along the fiber 666 to the first pigtail assembly 660 and through the first pigtail assembly 660 to the waveguide channel 622.

A pump light λₚ is transmitted along the fiber 678 to the second pigtail assembly 660 and the directional coupler 610. The pump light λₚ is divided by the pump beam splitters 630, 632, 634 into the coupler sections 616, 618, 620, 622 where the pump light λₚ transfers from the coupler section 616 to the waveguide channel 624 and combines with the signal light λ_{S1}. Pump light λₚ transfers from the coupler section 618 to the waveguide channel 122 and combines with the signal light λ_{S2}. Pump light λₚ transfers from the coupler section 620 to the waveguide channel 622 and combines with the signal light λ_{S3}. Pump light λₚ from the coupler section 621 dissipates in the waveguide 600 and does not couple into any waveguide channel. Preferably, the pump light λₚ is generated by pump, such as a 980 nm pump, a 1310 nm pump, or a 1480 nm pump, whose light excites rare earth elements in each waveguide channel 624, 122, 622, amplifying each signal light λ_{S1}, λ_{S2}, λ_{S3} in each respective waveguide channel 624, 122, 622. After amplification, amplified signal light λ_{S1}, λ_{S2}, λ_{S3} exits the second pigtail assembly 670 along fibers 672, 674, 676, respectively, for further transmission.

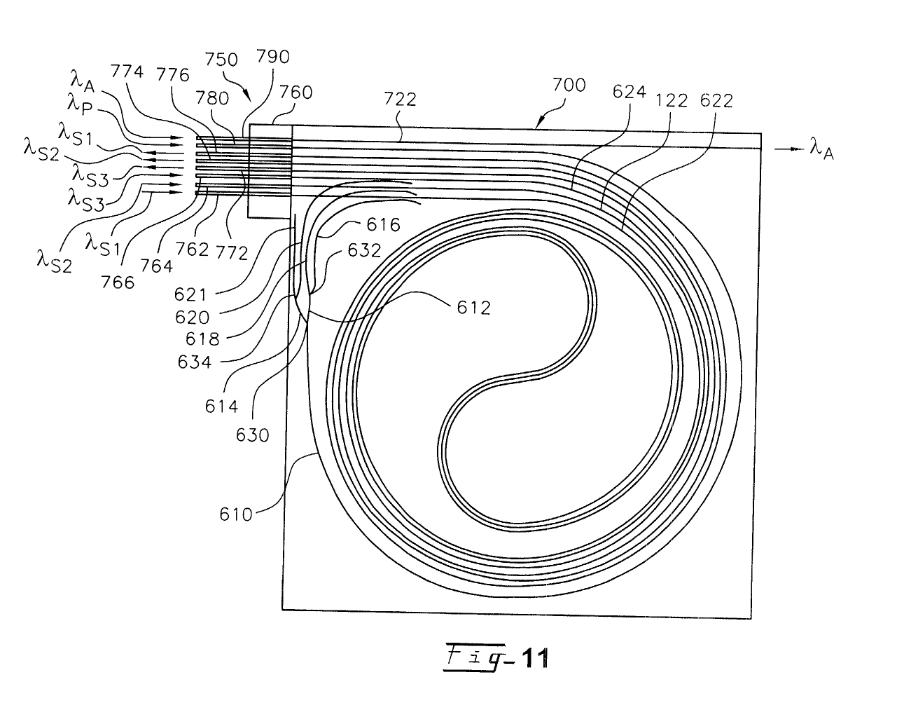

An alternate embodiment of a waveguide 700 is shown in FIG. 11. The waveguide 700 includes waveguide channels 122, 622, 624, was well as a reference channel 722. Preferably, the reference channel 722 is straight. The reference channel 722 can be an amplifying, or active channel, similar to the waveguide channels 122, 622, 624, or the reference channel 722 can simply be a passive channel. The reference channel 722 is used to align a pigtail assembly 760 to the waveguide 700, forming a waveguide assembly 750. In contrast to the waveguide assembly 650 shown in FIG. 10, the waveguide assembly 750 uses only the single pigtail assembly 760, with input fibers 762, 764, 766, output fibers 772, 774, 776, a pump fiber 780 and a reference fiber 790 comprising the pigtail assembly 760. The input fibers 762, 764, 766 are optically connected to inputs of the waveguide channels 622, 122, 624 respectively. The output fibers 772, 774, 776 are optically connected to outputs of the waveguide channels 624, 122, 622, respectively. The pump fiber 780 is optically connected to the directional coupler 610. The reference fiber 790 is optically connected to the reference channel 722.

After connecting the pigtail assembly 760 to the waveguide 700, a reference signal λ_{A} is transmitted along the reference fiber 790 and toward the reference channel 722. A receiver (not shown), such as a photodetector, measures the intensity of the reference signal λ_{A} at the output of the reference channel 722 as compared to the intensity of the reference signal λ_{A} as transmitted. When the pigtail assembly 760 is properly aligned to the waveguide 700, the reference signal λ_{A} will be transmitted through the reference channel 722 with minimal losses, such as a small (approximately 0.1 to 0.5 dB) coupling loss at the junction between the reference fiber 790 and the reference channel 722, as well as small transmission losses (approximately 0.1 to 1 dB) through the reference fiber 790 and the reference channel 722.

Operation of the waveguide 700 and waveguide assembly 750 is otherwise similar to the operation of the waveguide 600 and the waveguide assembly 650 as described above.

For the embodiments shown in FIGS. 9-11, the waveguide channels 122, 622, 624 can be in the same plane as the directional coupler 610 and the coupler sections 612, 614, 616, 618, 620, 622. A method for manufacturing the waveguides 500, 600, 700 with co-planar waveguides 122, 622, 624, the directional couplers 510, 610 and the coupler sections 612, 614, 616, 618, 620, 622 is disclosed in U.S. Provisional Patent Application Serial No. 60/309,849, filed on Aug. 3, 2001 (Attorney Docket No. PHX-0044), which is owned by the assignee of the present invention and is incorporated herein by reference in its entirety.

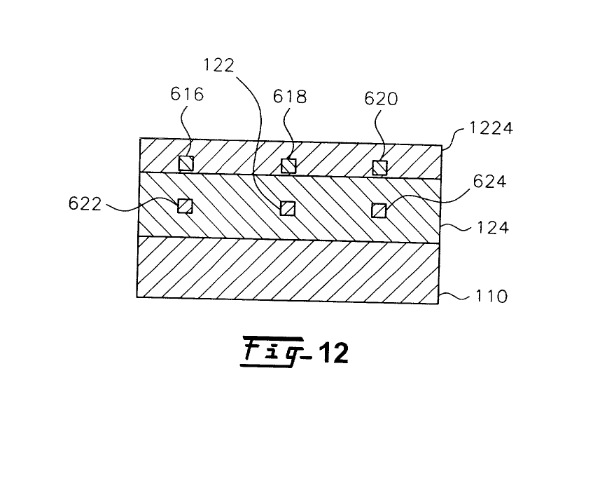

Alternatively, as shown in FIG. 12, a stacked waveguide 1200 can be fabricated, in which the waveguide channels 122, 622, 624 are formed in a first plane within the cladding region 124, and the directional coupler sections 616, 618, 620, 621 are then fabricated on top of the cladding region 124 in a plane separate from the plane containing the waveguide channels 122, 622, 624. An additional upper cladding 1224 is then disposed on top of the directional coupler sections 616, 618, 620, 621 and the cladding region 124. In this embodiment, cross-over loss between coupler section 618 and waveguide channel 624, as well as between coupler section 620 and waveguide channels 122, 624 is eliminated.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A channel optical waveguide comprising:
a substrate;
a first optical waveguide channel disposed on the substrate, the first optical waveguide channel including:
a first generally circular spiraling portion having a first free end and a first connected end;
a second generally circular spiraling portion having a second free end and a second connected end; and
a transition portion having:
a first transition section connected to the first connected end;
a second transition section connected to the second connected end; and
an inflection between the first and second transition sections; and
a directional coupler disposed on the substrate proximate the first free end.

2. The channel optical waveguide according to claim 1, further comprising a cladding layer disposed on the substrate, the optical waveguide channel being embedded in the cladding layer.

3. The channel optical waveguide according to claim 2, wherein the directional coupler is embedded in the cladding layer.

4. The channel optical waveguide according to claim 1, wherein the first and second generally circular spiraling portions are generally intertwined with each other.

5. The channel optical waveguide according to claim 1, wherein the inflection is generally in a geometric center of the channel waveguide optical amplifier.

6. The channel optical waveguide according to claim 1, wherein the first generally circular spiraling portion has an approximate first radius and the second generally circular spiraling portion has an approximate second radius approximately equal to the approximate first radius.

7. The channel optical waveguide according to claim 6, wherein the first transition section has an approximate transition radius approximately one half of the approximate first radius.

8. The channel optical waveguide according to claim 1, wherein the optical waveguide channel comprises a rare earth element doped material.

9. The channel optical waveguide according to claim 8, wherein the material is optical glass.

10. The channel optical waveguide according to claim 8, wherein the material is an optical polymer.

11. The channel optical waveguide according to claim 8, wherein the rare earth element is from the group consisting of lanthanum, cerium, praseodymium, neodymium, promethium, samarium, europium, gadolinium, terbium, dysprosium, holmium, erbium, thulium, ytterbium, and lutetium.

12. The channel optical waveguide according to claim 8, wherein the rare earth element comprises a first rare earth element and a second element.

13. The channel optical waveguide according to claim 12, wherein the second element is from the group consisting of lanthanum, cerium, praseodymium, neodymium, promethium, samarium, europium, gadolinium, terbium, dysprosium, holmium, erbium, thulium, ytterbium, lutetium, and aluminum.

14. The channel optical waveguide according to claim 1, wherein the first generally spiraling portion is governed by the equations X=(R+Δ·θ/2π)·cos θ; Y=(R+Δ·θ/2π)·sin θ, for θ=[2nπ, 0] and the second generally spiraling portion is governed by the equation X=(R+Δ·θ/2π+Δ/2)·cos θ; Y=(R+Δ·θ/2π+Δ/2)·sin θ, for θ=[−π, 2nπ], where:
n equals the number of turns on each of the first and second generally spiraling portions;
R is the smallest radius of the first generally spiraling portion;
X is an X coordinate on each of the first and second generally spiraling portions;
Y is a Y coordinate on each of the first and second generally spiraling portions, wherein with a center of the first and second generally spiraling portions has X,Y coordinates of 0,0;
Δ/2 is a separation of adjacent lines on each of the first and second generally spiraling portions; and
θ is an angle swept through by each of the first and second generally spiraling portions.

15. The channel optical waveguide according to claim 14, wherein the first transition section is governed by the equation X=(R/2)+(R/2)·cos θ; Y=(R/2)·sin θ, for θ=[0, −π] and the second transition section is governed by the equation X=(R/2)−(R/2)·cos θ; Y=(R/2)·sin θ, for θ=[0, π].

16. The channel optical waveguide according to claim 1, wherein the directional coupler is disposed to transmit light between the directional coupler and the optical waveguide channel.

17. The channel optical waveguide according to claim 1, further comprising at least a second optical waveguide channel disposed on the substrate, each of the at least second optical waveguide channels being generally parallel to the first optical waveguide channel.

18. The channel optical waveguide according to claim 17, wherein the directional coupler comprises a plurality of directional couplers, each of the plurality of directional couplers being disposed proximate one of the first and the at least second optical waveguide channels.

19. The channel optical waveguide according to claim 1, further comprising a reference channel disposed on the substrate.

20. The channel optical waveguide according to claim 19, wherein the reference channel is generally straight.

21. The channel optical waveguide according to claim 1, wherein the waveguide channel and the directional coupler are generally co-planar.

22. The channel optical waveguide according to claim 1, wherein the waveguide channel is disposed in a first plane and the directional coupler is disposed in a second, different plane.

23. A channel waveguide optical amplifier assembly comprising:
a waveguide optical amplifier including:
a substrate;
a cladding layer disposed on the substrate;
an optical waveguide channel disposed within the cladding layer, the optical waveguide channel including:
a first generally circular spiraling portion having a first free end and a first connected end;
a second generally circular spiraling portion having a second free end and a second connected end; and
a transition portion having:
a first transition section connected to the first connected end;
a second transition section connected to the second connected end; and
an inflection between the first and second transition sections;
a directional coupler disposed on the substrate proximate the first free end; and
a first pigtail assembly having a first input portion optically connected to the first free end and a second input portion optically connected to the directional coupler.

24. The channel waveguide optical amplifier assembly according to claim 23, further comprising a second pigtail assembly having a first output portion optical connected to the second free end.

25. The channel waveguide optical amplifier assembly according to claim 23, wherein the first and second generally circular spiraling portions are generally intertwined with each other.

26. The channel waveguide optical amplifier assembly according to claim 23, wherein the inflection is generally in a geometric center of the channel waveguide amplifier.

27. The channel waveguide optical amplifier assembly according to claim 23, wherein the first generally circular spiraling portion has an approximate first radius and the second generally circular spiraling portion has an approximate second radius approximately equal to the approximate first radius.

28. The channel waveguide optical amplifier assembly according to claim 27, wherein the first transition section has an approximate transition radius approximately one half of the approximate first radius.

29. The channel waveguide optical amplifier assembly according to claim 23, wherein the optical waveguide channel comprises a rare earth element doped material.

30. The channel waveguide optical amplifier assembly according to claim 29, wherein the material is optical glass.

31. The channel waveguide optical amplifier assembly according to claim 29, wherein the material is an optical polymer.

32. The channel waveguide optical amplifier assembly according to claim 29, wherein the rare earth element is from the group consisting of lanthanum, cerium, praseodymium, neodymium, promethium, samarium, europium, gadolinium, terbium, dysprosium, holmium, erbium, thulium, ytterbium, and lutetium.

33. The channel waveguide optical amplifier assembly according to claim 29, wherein the rare earth element comprises a first rare earth element and a second element.

34. The channel waveguide optical amplifier assembly according to claim 33, wherein the second element is from the group consisting of lanthanum, cerium, praseodymium, neodymium, promethium, samarium, europium, gadolinium, terbium, dysprosium, holmium, erbium, thulium, ytterbium, lutetium, and aluminum.

35. The channel optical waveguide assembly according to claim 23, wherein the first generally spiraling portion is governed by the equations X=(R+Δ·θ/2π)·cos θ; Y=(R+Δ·θ/2π)·sin θ, for θ=[2nπ, 0] and the second generally spiraling portion is governed by the equation X=(R+Δ·θ/2π+Δ/2)·cos θ; Y=(R+Δ·θ/2π+Δ/2)·sin θ, for θ=[−π, 2nπ], where:
n equals the number of turns on each of the first and second generally spiraling portions;
R is the smallest radius of the first generally spiraling portion;
X is an X coordinate on each of the first and second generally spiraling portions;
Y is a Y coordinate on each of the first and second generally spiraling portions, wherein with a center of the first and second generally spiraling portions has X,Y coordinates of 0,0;
Δ/2 is a separation of adjacent lines on each of the first and second generally spiraling portions; and
θ is an angle swept through by each of the first and second generally spiraling portions.

36. The channel optical waveguide assembly according to claim 35, wherein the first transition section is governed by the equation X=(R/2)+(R/2)·cos θ; Y=(R/2)·sin θ, for θ=[0, −π] and the second transition section is governed by the equation X=(R/2)−(R/2)·cos θ; Y=(R/2)·sin θ, for θ=[0, π].

37. The channel optical waveguide assembly according to claim 23, wherein the directional coupler is disposed to transmit light between the directional coupler and the optical waveguide channel.

38. The channel optical waveguide assembly according to claim 23, further comprising at least a second optical waveguide channel disposed on the substrate, each of the at least second optical waveguide channels being generally parallel to the first optical waveguide channel.

39. The channel optical waveguide assembly according to claim 38, wherein the first input portion is optically connected to each of the first and the at least second optical waveguide channels.

40. The channel optical waveguide assembly according to claim 39, further comprising a reference channel disposed on the substrate.

41. The channel optical waveguide assembly according to claim 38, wherein the first input portion is optically connected to the reference channel.

42. The channel optical waveguide assembly according to claim 39, wherein the first output portion is optically connected to each of the first and the at least second optical waveguide channels.

43. The channel optical waveguide assembly according to claim 42, wherein the directional coupler comprises a plurality of directional couplers, each of the plurality of directional couplers being disposed proximate one of the first and the at least second optical waveguide channels.

44. The channel optical waveguide assembly according to claim 23, further comprising a reference channel disposed on the substrate.

45. The channel optical waveguide according to claim 44, wherein the reference channel is generally straight.
